(19) United States
(12) Patent Application Publication
(10) Pub. No.: US 2007/0130310 A1
(43) Pub. Date: Jun. 7, 2007

(54) I/O Module with Web Accessible Product Data

(75) Inventors: Brian A. Batke, Novelty, OH (US); Gary W. Baczkowski, Seven Hills, OH (US); Kenwood H. Hall, Hudson, OH (US); Gregg Sichner, Mentor, OH (US); Jerry Penick, Shaker Heights, OH (US)

Correspondence Address: ROCKWELL AUTOMATION, INC./BF, ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/537,167

(22) Filed: Sep. 29, 2006

Related U.S. Application Data
(63) Continuation-in-part of application No. 09/967,724, filed on Sep. 28, 2001.

(51) Int. Cl. G06F 15/173

(52) U.S. Cl. 709/223

(57) ABSTRACT

An industrial control system provides I/O modules with web-servers and dual protocol ports so that product information stored in the I/O modules can be served over the same network interface used by the industrial control system to any Internet ready browser.

### CROSS REFERENCE TO RELATED APPLICATIONS

This application is a continuation in part of U.S. application Ser. No. 09/967,742 filed Sep. 28, 2001.

### FIELD OF THE INVENTION

The present invention relates generally to industrial controllers for controlling machines and industrial processes, and, in particular, to components for an industrial controller providing product data that is accessible through a standard web browser.

### BACKGROUND OF THE INVENTION

Industrial controllers are used to control and monitor industrial processes and machinery. A typical industrial controller includes a special-purpose computer that executes a stored control program to read inputs from and provide outputs to the controlled process, based on the logic of the control program.

Industrial controllers differ from conventional computers in two respects. First, industrial controllers are highly customizable to fit the demands of the particular industrial process being controlled. Typically, this customization is made possible by a modular construction which provides different components that may be added to the industrial controller to expand it for a particular application, most typically, I/O modules. The I/O modules may be distributed over a network communicating with a central processor of the industrial controller and generally include analog and digital inputs and outputs and for the purpose of this application more complex I/O systems such as motor controllers.

Second, industrial controllers, unlike conventional computers, must provide highly predictable and reliable, control outputs. In this regard, it is imperative both that the outputs and inputs be delivered in a timely fashion and that there be assurance that the outputs and inputs have, in fact, been communicated. For these reasons, industrial controllers use specialized control networks to connect their component parts, such as DeviceNet, ControlNet or EtherNet/IP, which may implement “connected messaging”. In connected messaging, the end devices of the message are “connected” before there is any communication, a process that ensures that there is sufficient band width on the network to handle the necessary communications as well as buffering and other resources to ensure that the message will be timely and accurately delivered. Connected messaging may be contrasted to, for example, the TCP/IP Internet protocol in which the delivery of packets and the time of delivery of the packets are not ensured.

The componentized nature of industrial controllers not only produces a system that is easily adapted to a wide variety of control applications but produces a system that may be easily upgraded as new components are developed or expanded as the application changes.

Each component of an industrial controller may have a complex set of specifications and configurations requirements normally contained in product literature associated with the component. Because the industrial controller is subject to expansion or modification over time, it is important that this data be preserved and readily available.

To this end, some types of product information may be presented on information plates attached to the components. Particularly for smaller components, this approach can be unsatisfactory. In all cases, the amount of information that may be physically attached to the components is practically limited to little more than a product number and name, a serial number, and the name of the manufacturer.

The limitations of physical information tags have lead to the embedding of product information in the memory of the component. Normally, this information is only available by using specialized programming software and may require that the industrial controller is operational with a fully functional network. Data of this type may not be readily available during the normal operation of the industrial controller or may require particular additional programming steps in order to extract.

### SUMMARY OF THE INVENTION

The present invention embedded product data into the memory of control modules of an industrial controller. Problems of accessing this information, particularly when the industrial controller has not been fully commissioned are avoided by coupling the data with a small web-server in the component that may serve the product data to any Internet compatible browser. Physically, the data may be served over the same network hardware used by the industrial controller, using a dual protocol network port.

By providing an embedded web-server and dual protocol capabilities, relatively little additional hardware is required to allow ready-access to arbitrary amounts of product information. The dual-protocol network port also allows the web-server to provide dynamic information about the controller component prior to commissioning of the industrial controller or human machine interfaces (HMIs) associated with the controller.

The incorporation of a web-server into the control modules further allows standard Internet devices, for example an Internet search appliance, to be used to interrogate the controller components to collect information both about the modules and the industrial control system as a whole with minimum programming effort and even before commissioning of the industrial controller or during operation of the industrial controller.

Specifically, the present invention provides an I/O module for use with an industrial control system having a controller executing a stored control program and communicating with a plurality of PO modules. The I/O modules receive sensed signals from an industrial process and output command signals to the industrial process, the latter according to the stored controlled program and the sensed signals. Each I/O module comprises a network interface providing network control communication between the I/O module and the controller, to exchange sensed signals and command signals, and providing network web communications between a web browser and the I/O module. The I/O modules also include a control signal protocol circuit communicating with the control network to receive command signals to drive the output lines attached to the industrial process according to the command signals and receive signals from the industrial process and transmit sensed signals according to the received signals. The I/O modules also include a web page memory holding at least some static data indicating the manufactured state of the I/O module and a web-server communicating with the web page memory and the control network to receive browser signals and to serve the static web data to a remote browser.

Thus, it is one object of the invention to provide a simple method of associating product information directly with an I/O module employing the computer processing and networking ability inherent in the module.

It is another object of the invention to provide embedded product information that is nearly universally accessible through standard browser Internet techniques.

It is another object of the invention to provide product data that can be accessed by standard Internet web query and web crawling tools.

The static data may, for example, be a serial number, a product model number, a product model name, manufacture date and manufacturer name.

It is thus another object of the invention to eliminate the need for large or accessible product information plates that are impractical for small I/O modules that may not support a large panel area.

The product data may, for example, be a user manual or a wiring diagram of the I/O module.

It is thus another object of the invention to provide for information that could not be captured on a product information plate attached to the product.

The static data may be a URL pointing to additional information specific to the I/O module.

It is thus another object of the invention to provide for that ability to update or supplement the product information after the sale of the I/O module.

The I/O module may further include I/O interface circuitry providing an electrical interface between the I/O module and input and output lines to the industrial process and a control system memory communicating with a processor and holding a stored program executed by the processor to moderate the communication of command and sensed signals between the control signal protocol circuit and the I/O interface circuitry. The execution of the program by the processor may produce command data stored in the control system memory and the web-server may communicate with the control system memory to serve the command data as browser signals via the network interface to a remote browser.

Thus, it is another object of the invention to allow the web-server to serve dynamic data indicating the current operating status of the I/O module.

The command data may, for example, be a fault condition of the I/O module detected by the processor, operating statistics of the I/O module, or the current state of the command and sensed signals reflected on the input and output lines.

Thus, it is an object of the invention to permit simple review of the basic operating state of the I/O module without the need to have the industrial controller fully programmed and operational.

The invention permits the construction of an industrial controller that incorporates a search function, for example, in a server or a dedicated search appliance communicating with the control network to accept a search query and to search through the web page memories of the connected I/O modules to provide a response to that query.

Thus, it is an object of the invention to enlist current technologically advanced hardware and software developed for the Internet to extract information from the I/O modules and thereby provide an integrated view of the components of the industrial controller.

The search appliance or the like may accept a query providing a listing of all I/O modules of a particular type determined by their qualities as manufactured.

Thus, it is an object of the invention to allow a simple overview of network control components using standard Internet search capabilities.

The search appliance or the like may itself include a web-server to accept a query and to serve query results to a remote browser.

It is thus another object of the invention to provide a simple method of interrogating the searching function does not require on the operation of the industrial controller.

The search appliance may serve its own web page, and that web page may graphically represent the fault state of multiple I/O modules connected to the control network. Each of the graphic representations on the web page may be linked to other web pages providing additional information about the I/O modules.

It is thus an object of the invention to provide a de-bugging tool that provides a simple overview of the operation of the components attached to the network prior to full operation of the network as an industrial controller.

These particular objects and advantages may apply to only some embodiments falling within the claims and thus do not define the scope of the invention.

### BRIEF DESCRIPTION OF THE DRAWINGS

FIG. 1 is a schematic representation of an industrial control system employing the present invention and providing a number of I/O modules communicating with a controller over a control network;

FIG. 2 is a detailed block diagram of one I/O module of FIG. 1 showing the dual protocol network port;

FIG. 3 is an example web page served by the I/O module of FIG. 2 such as may display both static and dynamic I/O data;

FIG. 4 is an example web page that may be served by a search appliance connected to the network of FIG. 1 showing the results of a query related to the type of I/O modules connected forming the industrial control system;

FIG. 5 is a figure similar to that of FIG. 4 showing an alternative web page served by the search appliance and showing fault status for each I/O module in a single visual image portions of which as are linked to detailed information about the I/O modules; and

FIG. 6 is a simplified block diagram of the search appliance.

### DETAILED DESCRIPTION OF THE PREFERRED EMBODIMENT

Referring now to FIG. 1, an industrial control system 10 may include a programmable logic controller 12 executing a stored control program and communicating with a plurality of I/O modules 22 to control an industrial process 14.

The programmable logic controller 12 communicates with the I/O modules using network medium 18 such as may support ControlNet, DeviceNet, Ethernet IP or other well-known industrial control communication protocols.

The I/O modules 22 receive command signals from the programmable logic controller 12 over the network medium 18 to produce outputs to various actuators 24 over output lines 26. The I/O modules 22 further receive inputs over input lines 28 from sensors 30 to provide sensed signals back over network medium 18 to the programmable logic controller 12. The inputs and outputs may be digital or analog signals or power signals or the like for motor control as is known in the art.

The programmable logic controller 12 may also communicate over the network medium 18 with a human machine interface such as a terminal 16 to provide for programming and control of the industrial control system 10.

As will be explained further below, network medium 18 supports not only a control protocol for sending control signals but also Internet-type communication, through the use of separate of interface circuits imposing the different high level protocols over a common low level protocol supported by the network medium 18. Accordingly, also attached to network medium 18 may be an Internet-type browser 32, for example, executing on a standard desk top computer and an Internet search appliance 34 as will be described below. Optionally a bridge 36 may connect the network medium 18 with the Internet 38 and one or more remote browsers 40.

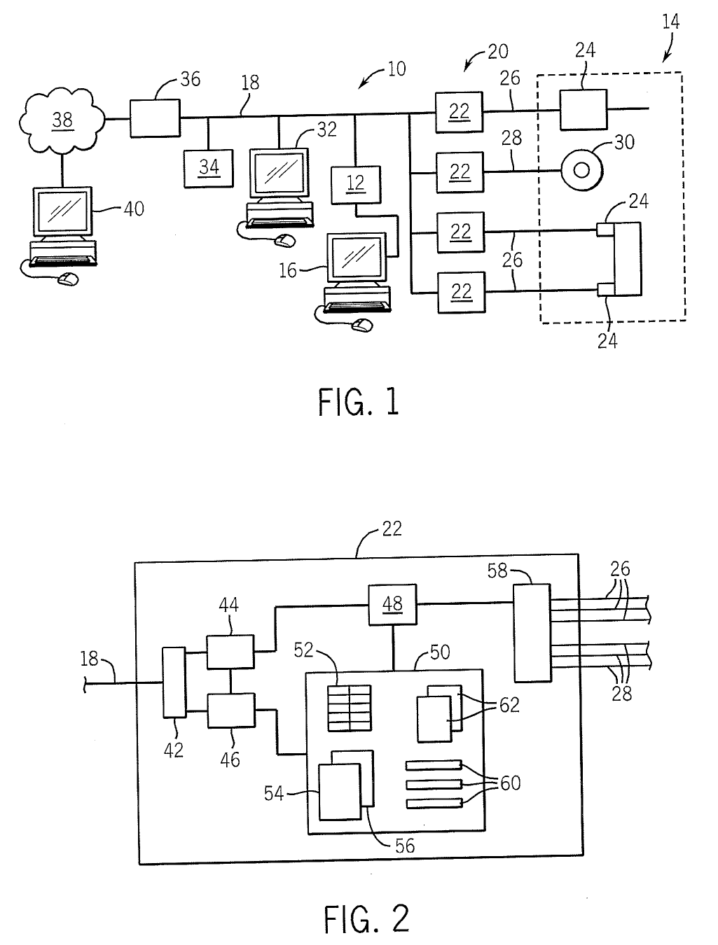

Referring now to FIG. 2, the I/O modules 22 each include a network interface 42 communicating with the network medium 18 to provide for network physical layer communication signals. The network interface 42 communicates signals along two separate signal paths, the first being through a control interface processor 44 used to provide bi-directional communication of control signals, for example, using a connected messaging protocol or other protocols suitable for industrial control. The second signal path is with a web-server 46 that may be used to exchange signals with a standard browser, such as browsers 32 or 40 described above with respect to FIG. 1.

The control interface processor 44 communicates with an internal processor 48 of the I/O module 22 to exchange command signals and sensed signals with the processor 48. The processor 48 communicates with memory 50 to executes a stored control program 54 normally developed for the particular industrial process 14 using a language such as relay ladder language or function block language well known in the art. Memory 50 may also include an operating system 56 providing a context for the execution of the control program 54 and providing other programmed characteristics as will be described below.

The processor 48 moderates the communication of sensed signals and command signals between network medium 18 and to the programmable logic controller 12 with an I/O interface circuit 58 which provides the necessary signal processing circuitry to communicate with input lines 28 and output lines 26 connected to sensors and actuators on the control machinery. In this regard, the processor 48 receives command signals over the network medium 18 and updates output values in an I/O table 52 in memory 50 and receives input signals from the input lines 28 to update input values in the I/O table 52. A scanning program periodically locks the I/O table 52 and reads though the I/O table 52 to transmit the output values along output lines 26 and to transmit the input values over network medium 18 according to a scanning protocol that helps ensure deterministic control. In the process of executing control program 54 and during the operation of the operating system 56 various non-PO values 60 may also be stored in memory, including, for example, I/O module status information, operating time since last reset, configuration information and the like.

Referring still to FIG. 2, as mentioned above, the web-server 46 also connects to network medium 18 through the network interface 42 to receive browser signals from and to serve web data to a remote browser. The web-server 46 also communicates with memory 50 which may hold web pages 62, incorporating static data entered into a non-volatile part of memory 50 at the time of manufacture of the I/O module 22. The static data of web pages 62 allows the PO modules 22 to carry extensive product information about the I/O module 22 that otherwise could be misplaced, lost or difficult to access. Such static data may, for example, include inherent characteristics of the I/O module 22, such as its manufacturing date, its model number, a serial number, user manual, wiring diagram, application notes and the like. In addition, the static data of static web pages 62 may include style sheets, logos, and a URL of the manufacturer or a URL of additional product information uniquely identified to this particular model of I/O module 22.

The web-server 46 may also have access to dynamic data in the memory 50 including the I/O table 52 and the non-I/O values 60 and thus may provide web pages 62 that have been augmented by data developed or collected during the operation of the I/O module.

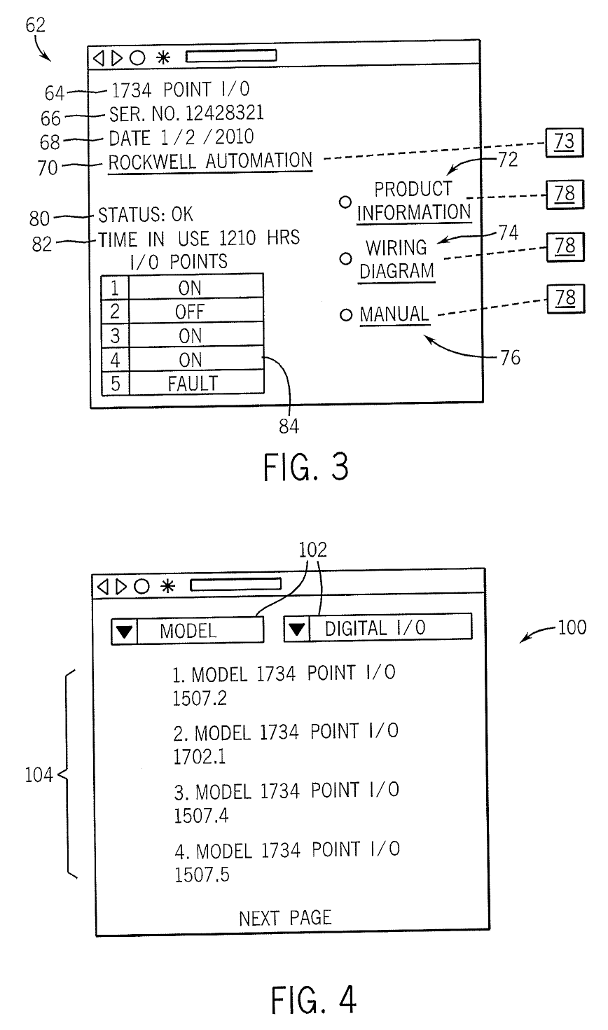

Referring now to FIG. 3, an example web page 62 as interpreted on a browser may, for example, include the model name and model number 64 of the I/O module 22, in this case, “1734 Point I/O” indicating that this is a “Point” I/O module with model number 1734. A serial number 66 also may be provided being simply a unique identifier for each I/O module 22 and the date of manufacturing 68. The manufacturer name 70 may be indicated and may be like using a standard HTML anchor to direct the browser to the URL to an internal or external corporate home page 73 of the manufacturer when the link is activated.

Similar links may be formed for product information 72, a wiring diagram 74 or user manual 76, each which may link to a corresponding web page 78 which may either be stored on a remote server or preferably may, in fact, be an additional web page 78 stored in memory 50. The static data served by the web-server 46 provides comprehensive labeling of the I/O module that may be read even when the I/O module is not incorporated into a control system with an industrial controller, simply by connecting a browser directly to the interface 42 with a short length of cable. In this way, the static data provides a virtual product tag.

Referring still to FIG. 3, the web page 62 may also incorporate dynamic data obtained from memory 50, as described, above using server-side scripts or other well known techniques. Such information may include fault information 80, indicating the status of the I/O module such as may be routinely determined by the processor 48 using watch dog and other diagnostic techniques well known in the art. The dynamic data may also include a time in service value 82 indicating how long the I/O module has been operating, which may be provided by the operating system 56 running a background task. The values in the I/O table 52 may also be presented on the web page in a table 84. The data provided by the web page 62, in this manner, may provide a virtual control panel for the I/O module 22, eliminating the need for an extensive control panel with lights and switches, a considerable advantage for compact I/O modules 22.

Referring now to FIGS. 1 and 6, the incorporation of this static and dynamic data into web pages served by an embedded web-server 46 in each of the I/O modules 22, allows the user to employ well developed Internet search technology to obtain a comprehensive view of the architecture and topology of the industrial controller without the need to develop specialized programs for each industrial control system 10. In one embodiment, this benefit is obtained by the addition of a standard Internet search appliance 34 to the network formed by network medium 18. The search appliance 34 may be a separate hardware component or may be a software component incorporated into a standard computer attached to the network medium 18 or may be a search engine operating remotely on the Internet 38.

Referring to FIG. 6, an example search appliance 34 provides for a physical network interface 86 compatible with the physical layer of network medium 18. The network interface 86 is connected to an Internet protocol circuit 88 suitable for decoding, for example, TCP/IP and also to a processor 90 executing a stored search program 92 and a web-server stack 94 allowing the Internet appliance to both execute arbitrary programs such as web crawlers and to present that data as a web page to one of the browsers 40 or 32 in a convenient fashion.

Referring now to FIG. 4, a web page 100 produced by the search appliance 34 may, for example, respond to a query provided by a user from a browser 32 or 40. As will be understood to those of ordinary skill in the art the web page 100 may present a simplified query language using drop down menus 102 or may provide for an arbitrary parsing of a Boolean query language, for example, of the type well known to those familiar with searching on the Internet using standard search engines. In this case, the dropdown menus allow the searching for a particular “model type”, being in this example “Digital I/O”. The search appliance 34 “searches” through the web pages 62 of all I/O modules 22 within the address space of the industrial control system 10 and present a search result 104 as a web page providing an indication of each of the I/O modules matching the search query requirements and other data about the I/O modules such as their addresses or a URL linking to their web pages 62 per standard search engine practice. As will be understood in the art, the query may not need be conducted in real time but may work with preprocessed information collected through crawling operations and collected in a concordance or database held within the memory 96 of the appliance 34. The data of the web page 62 may be tagged so as to be identifiable as to the context of the data using XML tags or the like.

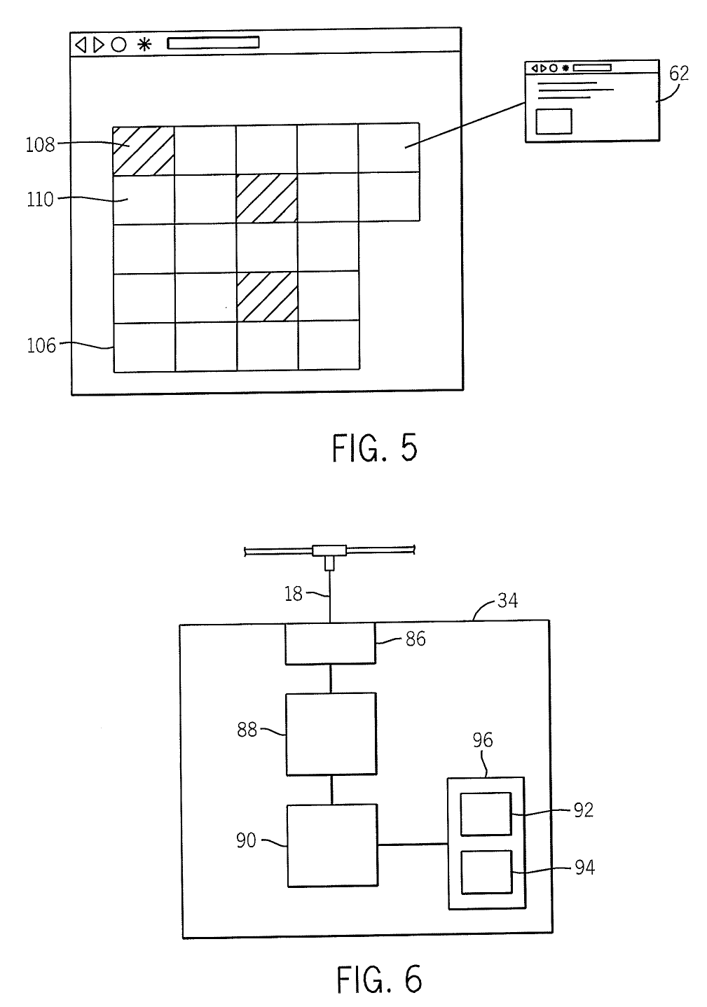

As shown in FIG. 4, the query has been constructed to investigate static data embedded in each of the I/O modules 22 at the time of manufacture, but referring to FIG. 5, a similar query may be performed on dynamic data, in this case, using techniques that push the data from each of the web-servers 46 outward so as to eliminate refresh problems

As shown in FIG. 5, the dynamic data for each of the I/O modules 22, for example, may be used to construct a so-called Christmas tree 106 providing for a checkerboard of squares each indicating one I/O module 22 and having a color either red 108 or green 110 indicating whether the particular I/O module is operational or not. In this way, the proper operation of the industrial control system 10 may be readily determined at a glance. Each of the squares which represent one I/O module 22 may be also linked to the web page 62 of the particular I/O module 22 as described above with respect to FIG. 3. The number of squares and their arrangement may be determined by a crawling operation without the intervention of the programmable logic controller 12. In this way, the entire network may be set up, debugged and verified prior to programming of the programmable logic controller 12.

It is specifically intended that the present invention not be limited to the embodiments and illustrations contained herein, but include modified forms of those embodiments including portions of the embodiments and combinations of elements of different embodiments as come within the scope of the following claims.

We claim:

1. An I/O module for use with an industrial control system having a controller executing a stored control program and communicating with a plurality of I/O modules, the I/O modules receiving sensed signals from an industrial process and outputting command signals to the industrial process according the stored control program and the sensed signals; the I/O module comprising:
(a) a network interface providing network control communication between the I/O module and the controller to exchange sensed signals and command signals and providing network Web communication between a Web browser and the I/O module;
(b) a control signal protocol circuit communicating with the control network interface to:
(i) receive the command signals to drive output lines attached to the industrial process according to the command signals;
(ii) receive signals from the industrial process and transmit sensed signals according to the received signals;
(c) a Web page memory holding a least some static data indicating a manufactured state of the I/O module;
(d) a Web-server communicating with the Web page memory and the control network to receive browser signals and to serve the static Web data to a remote browser;
whereby browser accessible information about the I/O module can be embedded in the I/O module at a time of manufacture.

2. The I/O module of claim 1 wherein the static data selected from the group consisting of: a serial number; a product model number; a product model name; manufactured date; and a manufacturer name.

3. The I/O module of claim 1 wherein the static data is a user manual for the I/O module.

4. The I/O module of claim 1 wherein the static data is a wiring diagram of the I/O module.

5. The I/O module of claim 1 wherein the static data is a URL pointing to additional information specific to the I/O module.

6. The I/O module of claim 1 wherein the I/O module further includes:
I/O interface circuitry providing an electrical interface between the I/O module and input and output lines communicating with the industrial process;
a control system memory;
a processor executing a stored program to moderate the communication of command and sensed signals between the control signal protocol circuit and the I/O interface circuitry producing command data associated with this operation and stored in the control system memory;
wherein the Web-server may communicate with the control system memory to serve command data as browser signals via the network interface.

7. The I/O module of claim 6 wherein the command data indicated a fault in an operation of the I/O module detected by the processor.

8. The I/O module of claim 6 wherein the command data is operating statistics of the I/O module.

9. The I/O module of claim 6 wherein the command data includes a current state of command and sensed signals.

10. An industrial control system comprising:
(a) at least one control network;
(b) an industrial controller;
(c) a plurality of I/O modules communicating with the industrial controller over the control network to receive sensed signals from an industrial process and outputting command signals to the industrial process according a stored control program executed by the industrial controller; the I/O modules including:
(i) a Web page memory holding browser accessible static data;
(ii) a Web-server communicating with the Web page memory to receive browser signals and to serve the static data to a remote browser over the control network;
(d) a search appliance communicating with the control network to accept a search query and to search through the Web page memories of the connected I/O modules to provide a response to that query.

11. The I/O module of claim 10 wherein the search appliance may accept a query providing a listing of all I/O modules of a particular type determined by their qualities as manufactured.

12. The I/O module of claim 10 further including:
(iii) an I/O module memory holding browser accessible dynamic data related to an operation of the I/O module in processing sensed and command signals, the Web-server also communicating with the I/O module memory to serve the dynamic data to a remote browser over the control network.

13. The I/O module of claim 12 whereby the search appliance may accept a query describing functions of I/O modules.

14. The I/O module of claim 12 whereby the search appliance may provide query results showing static or dynamic data from the Web page memory or the I/O module memory.

15. The I/O module of claim 10 wherein the search appliance includes a web-server to serve query results to a remote browser.

16. The I/O module of claim 10 wherein the search appliance provides a web page graphically representing a fault state of multiple I/O modules connected on the control network.

17. The I/O module of claim 16 wherein the graphic representation of the fault states are linked to pages providing information about the I/O modules.
